(19) United States
(12) Patent Application Publication
(10) Pub. No.: US 2025/0208579 A1
(43) Pub. Date: Jun. 26, 2025

(54) COVER STRUCTURAL BODY, TIMEPIECE AND COVER STRUCTURAL BODY MANUFACTURING METHOD

(71) Applicant: CASIO COMPUTER CO., LTD., Tokyo (JP)

(72) Inventor: Tomoyasu KUROKAWA, Tokyo (JP)

(21) Appl. No.: 18/988,109

(22) Filed: Dec. 19, 2024

(30) Foreign Application Priority Data
Dec. 20, 2023 (JP) 2023-214627
Nov. 25, 2024 (JP) 2024-205044

(51) Int. Cl. G04B 37/22; G04B 37/18

(52) U.S. Cl. CPC G04B 37/225; G04B 37/18

(57) ABSTRACT

A cover structural body including a cover member through which at least visible light passes and which is provided with at least one first positioning mark portion that absorbs visible light, a semi-light-transmissive layer which is provided below the first positioning mark portion while extending around the first positioning mark portion in a planar view from a certain direction, through which light of certain visible wavelength bands passes, and by which light of other visible wavelength bands is absorbed, and a cover target member which is provided under the semi-light-transmissive layer, and in which at least one second positioning mark portion where visible light passes through is provided at a portion to be covered by the first positioning mark portion in the planar view from the certain direction.

### CROSS-REFERENCE TO RELATED APPLICATIONS

This application is based upon and claims the benefit of priority from the prior Japanese Patent Applications No. 2023-214627 filed Dec. 20, 2023, and No. 2024-205044 filed Nov. 25, 2024, the entire contents of which are incorporated herein by reference.

### BACKGROUND

### 1. Technical Field

The present disclosure relates to a cover structural body that is used for electronic devices such as timepieces and meter gauges, a timepiece having the cover structural body, and a manufacturing method for the cover structural body.

### 2. Description of the Related Art

For example, a wristwatch is know which has a structure where a watch glass has been provided on the upper opening of a wristwatch case, a transparent dial plate has been arranged under the watch glass, and a timepiece movement and a solar panel have been parallelly arranged under the dial plate, as described in Japanese Patent Application Laid-Open (Kokai) Publication No. 2004-069626.

In this wristwatch, a light-blocking sticker is directly attached to the upper surface of the timepiece movement on the inner circumference side of the solar panel so that the timepiece movement cannot be seen from the outside through the transparent dial plate.

### SUMMARY

An embodiment of the present disclosure is a cover structural body comprising: a cover member through which at least visible light passes and which is provided with at least one first positioning mark portion that absorbs visible light; a semi-light-transmissive layer which is provided at same height as or below the first positioning mark portion while extending around the first positioning mark portion in a planar view from a certain direction, through which light of certain visible wavelength bands passes, and by which light of other visible wavelength bands is absorbed; and a cover target member which is provided under the semi-light-transmissive layer, and in which at least one second positioning mark portion where visible light passes through is provided at a portion to be covered by the first positioning mark portion in the planar view from the certain direction.

The above and further objects and novel features of the present disclosure will more fully appear from the following detailed description when the same is read in conjunction with the accompanying drawings. It is to be expressly understood, however, that the drawings are for the purpose of illustration only and are not intended as a definition of the limits of the disclosure.

### BRIEF DESCRIPTION OF THE DRAWINGS

FIG. 1 is an enlarged planar view showing an embodiment in which the present disclosure has been applied in a wristwatch;

FIG. 2 is an enlarged sectional view showing a main portion of the wristwatch taken along the A-A arrow view in FIG. 1;

FIG. 3 is an enlarged sectional view of the B portion of a glass structural body shown in FIG. 2;

FIG. 4 is an enlarged planar view showing the glass structural body of FIG. 1 when viewed from above;

FIG. 5 is an enlarged planar view showing a watch glass provided with a functional display section, a light absorption layer, and first positioning mark sections in the glass structural body shown in FIG. 4;

FIG. 6 is an enlarged planar view showing a semi-light-transmissive layer provided under the watch glass shown in FIG. 4;

FIG. 7 is an enlarged planar view showing a solar panel that is attached under the watch glass in FIG. 4;

FIG. 8A is an enlarged view of a main portion of the glass structural body shown in FIG. 4, in which a positioning portion at the C portion on the nine o'clock side in FIG. 4 is shown;

FIG. 8B is an enlarged view of a main portion of the glass structural body shown in FIG. 4, in which a positioning portion at the D portion on the three o'clock side in FIG. 4 is shown;

FIG. 9A is an enlarged view showing the mispositioning of a second positioning mark section with respect to a first positioning mark section in the positioning state shown in FIG. 8A, which is mispositioning at the positioning portion on the nine o'clock side; and

FIG. 9B is an enlarged view showing the mispositioning of a second positioning mark section with respect to a first positioning mark section in the positioning state shown in FIG. 8B, which is mispositioning at the positioning portion on the three o'clock side.

### DETAILED DESCRIPTION OF THE PREFERRED EMBODIMENT

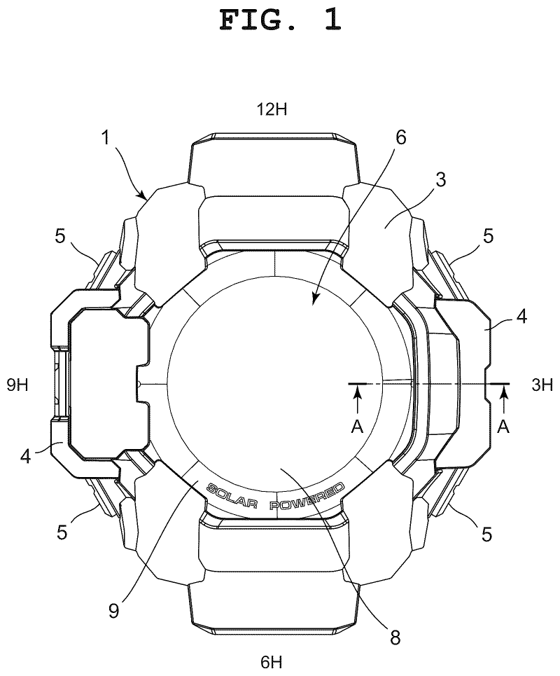

An embodiment in which the present disclosure has been applied in a wristwatch will hereinafter be described with reference to FIG. 1 to FIG. 9.

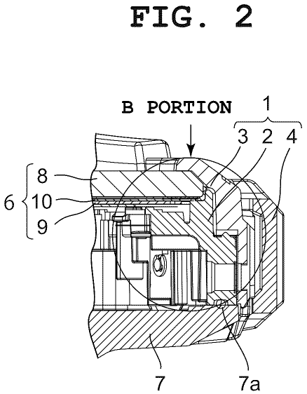

This wristwatch includes a wristwatch case 1, as shown in FIG. 1 and FIG. 2. The wristwatch case 1 includes a case main body 2, a first exterior member 3, and a second exterior member 4.

The case main body 2 is made of a metal such as stainless steel or a highly rigid synthetic resin. The first exterior member 3, which is attached to the outer circumferential surface of the upper part of the case main body 2, is made of an elastic synthetic resin such as urethane resin, and the second exterior member 4, which protects the three and nine o'clock sides of the first exterior member 3, is made of a metal such as stainless steel.

On the two o'clock side, four o'clock side, eight o'clock side, nine o'clock side, and ten o'clock side of the wristwatch case 1, push-button switches 5 are provided, as shown in FIG. 1. On the upper opening of this wristwatch case 1, that is, on the upper part of the case main body 2, a glass structural body 6 is provided which is a cover structural body for covering an internal component such as a timepiece module, as shown in FIG. 2. In addition, to the lower part of this wristwatch case 1, that is, to the lower part of the case main body 2, a back cover 7 is attached via a waterproof packing 7a. Inside this wristwatch case 1, a timepiece module (not shown in the drawings) is provided.

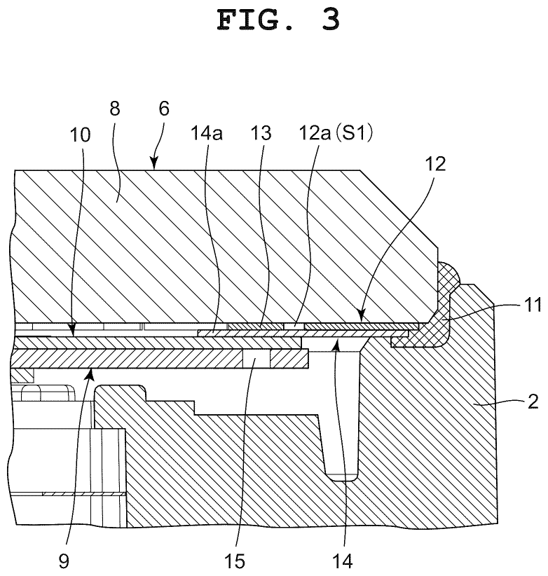

The glass structural body 6 includes a watch glass 8 which is a cover member, and a solar panel 9 which is a cover target member, as shown in FIG. 2 and FIG. 3. This glass structural body 6 has a structure where the solar panel 9 has been attached to the undersurface of the watch glass 8 by a transparent double-sided adhesive tape 10 (where light of most wavelengths in the visible light band passes through). In the present embodiment, this watch glass 8 is a transparent glass plate where at least visible light passes through (light of most wavelengths in the visible light band passes through), and has a disc-like shape. The outer circumferential part of this watch glass 8 is arranged on an outer circumferential portion of the upper part of the case main body 2 and fixed thereto by an adhesive 11.

In the present embodiment, the solar panel 9 is constituted by, for example, a silicon-based semiconductor material such as monocrystalline silicon or polycrystalline silicon, or a gallium-based semiconductor material. In general, the color of the cells of solar panels is relatively black or a color close to black, such as gray close to black, dark blue, and dark purple. The color of the solar panel 9 of the present embodiment is gray close to black.

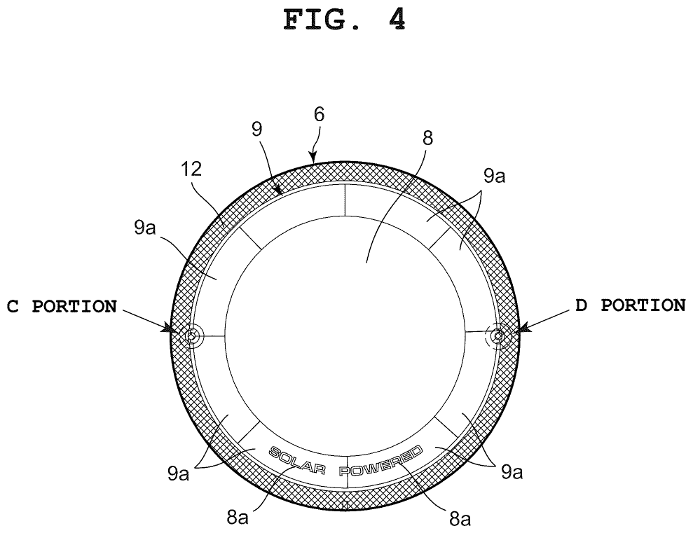

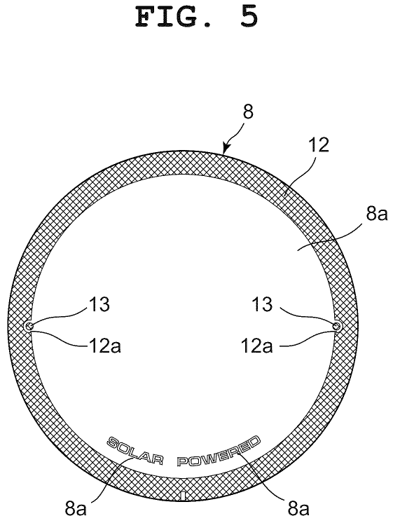

On the outer circumferential part of the undersurface of the watch glass 8, a light absorption layer 12 which absorbs visible light is substantially annularly provided by silk printing, as shown in FIG. 4 and FIG. 5. For convenience of description, the diameter of the outer side of the substantially annular light absorption layer 12 in a planar view from above is referred to as “outer diameter”, and the diameter of the inner side thereof is referred to as “inner diameter”. Note that the inner diameter herein is defined as the length of the diameter of the inner side of the light absorption layer 12 when there are no concavity and convexity formed by cutout sections 12a and first positioning mark sections 13 described later (the same applies to a semi-light transmitting layer 14 described later). This light absorption layer 12 is, for example, a black layer and formed such that its outer diameter is substantially equal to the outer diameter of the watch glass 8, and its inner diameter is substantially equal to the outer diameter of the solar panel 9, or equal to or shorter than the outer diameter of the solar panel 9 and longer than the inner diameter of the solar panel 9. On a portion of the undersurface of the watch glass 8 located on the inner circumference side of the light absorption layer 12, a function display section 8a which displays a clock function and the like is provided in an arc shape along the outer circumference of the solar panel 9. The function display section 8a should preferably be printed in light transmissive ink in order to increase the light receiving amount of the solar panel 9.

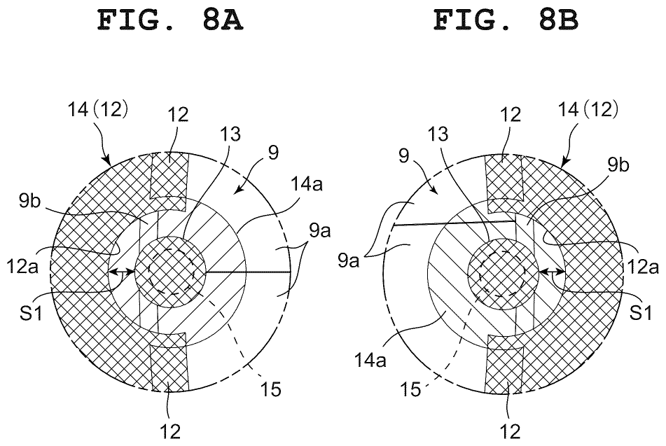

Also, on the nine o'clock side and three o'clock side of the light absorption layer 12, the semicircular cutout sections 12a are formed to be open on the inner circumference side of the light absorption layer 12, as shown in FIG. 8A and FIG. 8B. The “inner diameter” of each semicircular cutout section 12a, which is referred to for descriptive purposes, denotes the diameter of a circle formed by the arc of its semicircular shape being extended in a planar view from above (the same applies to each cover section 14a described later). On portions of the undersurface of the watch glass 8 located in each cutout section 12a on the nine o'clock side and three o'clock side of the light absorption layer 12, the first positioning mark sections 13 are provided by silk printing. Each first positioning mark section 13 is a layer that absorbs visible light, and formed in a substantially circular shape whose outer diameter is shorter than the inner diameter of each cutout section 12a.

Each first positioning mark section 13 is formed such that its outer diameter is substantially equal to the radius of each cutout section 12a, as shown in FIG. 8A and FIG. 8B. These first positioning mark sections 13 are provided such that their center portions respectively correspond to center portions of the cutout sections 12a on the nine o'clock side and three o'clock side of the light absorption layer 12. As a result, each first positioning mark section 13 is provided with a space S1 being formed between its outer circumferential portion and the inner circumferential part of the corresponding cutout section 12a on the nine o'clock side or three o'clock side of the light absorption layer 12.

Here, the light absorption layer 12 may coincide with part of each space S1 between each first positioning mark section 13 and the light absorption layer 12. For example, by a plurality of straight lines being extended from inner circumferential portions of the light absorption layer 12 to each first positioning mark section 13, positioning therefor can be performed via the semi-light-transmissive layer 14, and each space S1 can be obscured to some extent by the color of black by the light absorption layer 12.

The light absorption layer 12 is provided avoiding the first positioning mark sections 13 so as not to come in contact or coincide with the first positioning mark sections 13, as shown in FIG. 8A and FIG. 8B. Also, each first positioning mark section 13 is provided on the inner circumference side of the light absorption layer 12, that is, on the inner circumferential rim thereof such that part of its outer circumferential rim protrudes from the corresponding cutout section 12a of the light absorption layer 12 and is located closer to the inner side than the inner circumferential part of the light absorption layer 12.

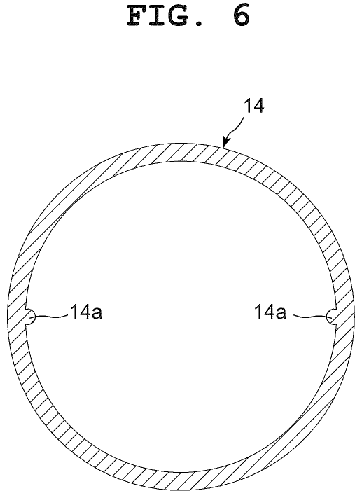

Under the light absorption layer 12 and the first positioning mark sections 13, the semi-light-transmissive layer 14 where visible light passes through is substantially annularly provided by medium printing, as shown in FIG. 3 and FIG. 6. This semi-light-transmissive layer 14 is a translucent layer which enhances adhesiveness with respect to the case main body 2, the light absorption layer 12, and the first positioning mark sections 13, and colored by, for example, a black color material.

The transmissivity of the semi-light-transmissive layer 14 is not 100% at all wavelengths in the visible light band. For example, the semi-light-transmissive layer 14 absorbs at least some wavelengths such as wavelengths in the blue band (400-500 nm), wavelengths in the red band (650-750 nm), and wavelengths in the green band (500-550). The semi-light-transmissive layer 14 of the present embodiment is a layer where light of all wavelengths in the visible light band substantially equally passes through. In addition, the “semi-light-transmissive” herein is merely an expression for convenience of description and does not refer to a light transmittance of 50% as will be described later. This semi-light-transmissive layer 14 is formed such that its inner diameter is substantially equal to that of the light absorption layer 12 and its outer diameter is slightly shorter than that of the light absorption layer 12.

On the nine o'clock side and three o'clock side of the semi-light-transmissive layer 14, the cover sections 14a, each of which is an overlapping portion, are formed to cover the cutout sections 12a of the light absorption layer 12 and the first positioning mark sections 13 from below, as shown in FIG. 6 and FIG. 8. Each cover section 14a is formed in a substantially semicircular shape, and its outer diameter is slightly longer than the inner diameter of each cutout section 12a of the light absorption layer 12. As a result, each cover section 14a serves as a tinted section for tinting (obscuring) where only a certain amount of visible light passes through, which is provided projecting in a semicircular shape from an inner circumferential portion of the semi-light-transmissive layer 14 while overlapping with the circumferential rim of the corresponding cutout section 12a.

As a result of this structure, a certain amount of visible light passes through at a portion of each cover section 14a coinciding with the corresponding space S1 between the outer circumferential part of the corresponding first positioning mark section 13 and the inner circumferential part of the corresponding cutout section 12a and a portion of each cover section 14a coinciding with and adjacent to an outer circumferential rim portion of the corresponding first positioning mark section 13 located at the inner circumference of the light absorption layer 12 (that is, portions extending corresponding to the light absorption layer 12 and around each first positioning mark section 13), as shown in FIG. 8A and FIG. 8B. Here, the light transmittance of the semi-light-transmissive layer 14 and those of the cover sections 14a are 5% to 15%, and should preferably be 10%.

Also, the light transmittance of the light absorption layer 12 and those of the first positioning mark sections 13 are set lower than the light transmittance of the semi-light-transmissive layer 14 and those of the cover sections 14a. More specifically, when the light transmittance of the semi-light-transmissive layer 14 and those of the cover sections 14a are about 10%, the light transmittance of the light absorption layer 12 and those of the first positioning mark section 13 are 0% to 5%, and should preferably be 0% (visible light does not pass therethrough at all).

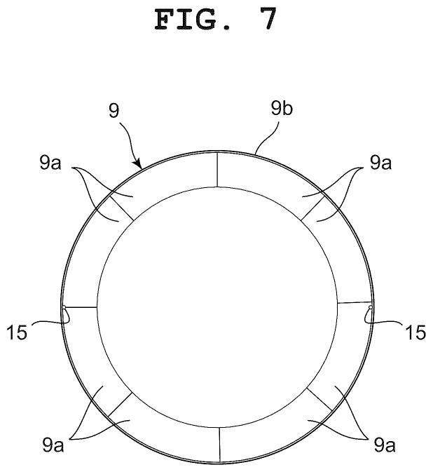

The solar panel 9, which is attached under the watch glass 8, is substantially annularly formed such that its outer diameter is substantially equal to the inner diameter of the light absorption layer 12 or longer than the inner diameter of the light absorption layer 12, and its inner diameter is located more medially than the array area of the function display section 8a of the watch glass 8, as shown in FIG. 4 and FIG. 7. This solar panel 9, which receives external light that has passed through the watch glass 8 and generates electromotive force, has a plurality of cells 9a arranged annularly. These plural cells 9a are connected to one another by a connection wiring section 9b provided on the outer circumferential part of the solar panel 9, whereby the solar panel 9 is electrically connected to the timepiece module (not shown in the drawings) in the wristwatch case 1.

In outer circumferential portions of the solar panel 9 on the nine o'clock side and the three o'clock side, second positioning mark sections 15 are provided which are covered by the first positioning mark sections 13, as shown in FIG. 7 and FIG. 8. Each second positioning mark section 15 is a circular through hole vertically penetrating through the solar panel 9, and formed such that its outer diameter is shorter than that of each first positioning mark section 13, as shown in FIG. 3.

As a result, in the case of this glass structural body 6, visible light is emitted from under the solar panel 9 toward the second positioning mark sections 15, and applied to the cover sections 14a of the semi-light-transmissive layer 14 through the through holes of the second positioning mark sections 15. Then, part of this light passes through the cover sections 14a of the semi-light-transmissive layer 14 and is applied to the first positioning mark sections 13. When this visible light is substantially completely absorbed at the first positioning mark sections 13, it is detected that the solar panel 9 has been correctly positioned under the watch glass 8, as shown in FIG. 8A and FIG. 8B.

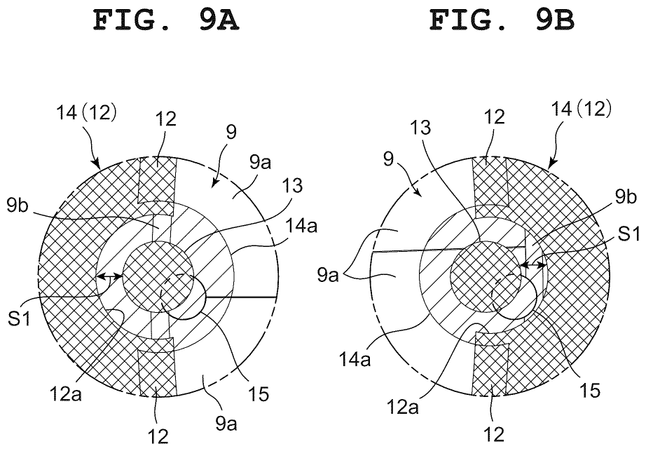

Also, in the case of this glass structural body 6, when the visible light emitted from under the solar panel 9 toward the second positioning mark sections 15 is not fully absorbed at the first positioning mark sections 13, leaks above the first positioning mark sections 13, and is seen from above the watch glass 8 as shown in FIG. 9A and FIG. 9B, it is detected that the second positioning mark sections 15 have been mispositioned with respect to the first positioning mark sections 13.

In the present embodiment, this situation where the second positioning mark sections 15 of the glass structural body 6 have been mispositioned with respect to the first positioning mark sections 13 and located at positions shifted therefrom as shown in FIG. 9A and FIG. 9B is not acceptable. Here, areas required to be tinted (obscured) in the present embodiment are areas which can be seen through the spaces S1, that is, areas between the light absorption layer 12 and the solar panel 9 (or each first positioning mark section 13). By being translucent, that is, by being tinted by the cover sections 14a of the semi-light-transmissive layer 14, these areas are obscured not to be easily seen.

As a result, in the case of this glass structural body 6, the timepiece module (not shown in the drawings) in the wristwatch case 1 is obscured by the cover sections 14a of the semi-light-transmissive layer 14 so as not to be seen from the outside through the tinting (obscuring) target areas which can be seen from the spaces S1. Also, the colors of the light absorption layer 12, the first positioning mark sections 13, the semi-light-transmissive layer 14, and the solar panel 9 are in the same color system. Accordingly, the timepiece module (not shown in the drawings) in the wristwatch case 1 is further obscured so as not to be seen from the outside. Note that the “same color system” herein refers to black or a color close to black, such as gray close to black, dark blue, and dark purple. For example, if the color of the solar panel 9 is a color close to blue, the light absorption layer 12, the first positioning mark sections 13, and the semi-light-transmissive layer 14 may be colored in a color close to blue.

Next, a manufacturing method for manufacturing the glass structural body 6 of this wristwatch is described.

This manufacturing method includes a first step of providing the first positioning mark sections 13 and the semi-light-transmissive layer 14 under the watch glass 8, a second step of providing the second positioning mark sections 15 in the solar panel 9, a third step of emitting visible light from under the solar panel 9 and detecting the positioning of the second positioning mark sections 15 and the first positioning mark sections 13, and a fourth step of attaching the solar panel 9 subjected to the positioning to the watch glass 8.

At the first step, first, the light absorption layer 12 and the first positioning mark sections 13 are printed on the undersurface of the watch glass 8 by silk printing. In the present embodiment, the light absorption layer 12 is substantially annularly formed on the outer circumferential part of the undersurface of the watch glass 8. In addition, the semicircular cutout sections 12a are formed on the nine o'clock side and three o'clock side of the light absorption layer 12, and the first positioning mark sections 13 are formed in these cutout sections 12a.

Here, each first positioning mark section 13 is circularly formed such that its area is smaller than the area of the corresponding cutout section 12a, and the corresponding space S1 is formed between its outer circumferential part and the inner circumferential part of the cutout section 12a. Also, this first positioning mark section 13 is provided such that a portion of its outer circumferential part, or more specifically, its outer circumference rim portion that is located on the inner circumferential side of the light absorption layer 12 projects from the cutout section 12a toward the inner circumference side of the light absorption layer 12.

Also, at the first step, the semi-light-transmissive layer 14 is formed on the undersurface of the watch glass 8 having the light absorption layer 12 and the first positioning mark sections 13 by medium printing. This semi-light-transmissive layer 14 is a translucent layer where only a certain amount of visible light passes through, and the cover sections 14a are formed on the nine o'clock side and three o'clock side thereof. Each cover section 14a is formed projecting semicircularly from the inner circumferential part of the semi-light-transmissive layer 14 while coinciding with the circumferential rim part of the corresponding cutout section 12a.

As a result, a certain amount of visible light passes through at the portion of each cover section 14a coinciding with the corresponding space S1 between the outer circumferential part of the corresponding first positioning mark section 13 and the inner circumferential part of the corresponding cutout section 12a and the portion of each cover section 14a coinciding with and adjacent to the outer circumferential rim portion of the corresponding first positioning mark section 13 located at the inner circumference of the light absorption layer 12, as shown in FIG. 8A and FIG. 8B.

At the second step, the second positioning mark sections 15 are formed on the nine o'clock side and three o'clock side of the solar panel 9. Each of these second positioning mark sections 15 is a through hole where light passes, and its inner diameter is formed shorter than the outer diameter of each first positioning mark section 13. As a result, when arranged under and corresponding to the first positioning mark sections 13, the second positioning mark sections 15 are covered by the first positioning mark sections 13.

At the third step, visible light is emitted from under the solar panel 9 toward the watch glass 8 side, and the positioning of the second positioning mark sections 15 of the solar panel 9 and the first positioning mark sections 13 of the watch glass 8 is detected. Here, when visible light is emitted from under the solar panel 9 toward the second positioning mark sections 15, this emitted visible light is applied to the cover sections 14a of the semi-light-transmissive layer 14 through the through holes of the second positioning mark sections 15, and part of this visible light passes through the cover sections 14a of the semi-light-transmissive layer 14 and is applied to the first positioning mark sections 13.

Here, when the emitted visible light is substantially completely absorbed at the first positioning mark sections 13, it is detected that the solar panel 9 has been correctly positioned under the watch glass 8. Conversely, when the visible light emitted from under the solar panel 9 toward the second positioning mark sections 15 is not fully absorbed at the first positioning mark sections 13, leaks above the first positioning mark sections 13, and is seen from above the watch glass 8 as shown in FIG. 9A and FIG. 9B, it is detected that the second positioning mark sections 15 have been mispositioned with respect to the first positioning mark sections 13.

In the present embodiment, this situation where the second positioning mark sections 15 of the solar panel 9 have been mispositioned with respect to the first positioning mark sections 13 and located at positions shifted therefrom as shown in FIG. 9A and FIG. 9B is not acceptable. Here, areas required to be tinted (obscured) in the present embodiment are areas which can be seen through the spaces S1, that is, areas between the light absorption layer 12 and the solar panel 9 (or each second positioning mark section 15). If these areas are seen from diagonally above, the internal structure such as the timepiece module (not shown in the drawings) in the wristwatch case 1 is also seen undesirably. Thus, in the present embodiment, by being translucent, that is, by being tinted by the cover sections 14a of the semi-light-transmissive layer 14, these areas are obscured not to be easily seen.

At the fourth step, the solar panel 9 subjected to the positioning is attached to the watch glass 8 by the transparent double-sided adhesive tape 10. That is, the solar panel 9 is attached under the watch glass 8 by the transparent double-sided adhesive tape 10 with the second positioning mark sections 15 of the solar panel 9 being positioned corresponding to the first positioning mark sections 13 of the watch glass 8. As a result, the solar panel 9 can receive external light through the transparent double-sided adhesive tape 10. After this step, the manufacture of the glass structural body 6 is ended.

The watch glass 8 of the glass structural body 6 manufactured as described above is arranged on the outer circumferential part of the upper side of the case main body 2 and fixed by the adhesive 11, as shown in FIG. 3. In this state, when the first exterior member 3 is attached to the outer circumferential surface of the upper part of the case main body 2, the outer circumferential part of the upper surface of the watch glass 8 is held down by the second exterior member 4, as shown in FIG. 2.

Then, the second exterior member 4 is attached to the three o' clock side and nine o' clock side of the first exterior member 3, whereby the assembly of the wristwatch case 1 is ended. Next, the timepiece module (not shown in the drawings) is provided in the wristwatch case 1 and, in this state, the back cover 7 is attached to the lower part of the wristwatch case 1 together with the waterproof packing 7a, whereby the assembly of the wristwatch is ended.

As such, the glass structural body 6 of the wristwatch includes the watch glass 8 which is a cover member where at least visible light passes through and provided with at least one first positioning mark section 13 which absorbs visible light, the semi-light-transmissive layer 14 which is provided at the same height as or below the first positioning mark section 13 while extending around the first positioning mark section 13 in a planar view from above that is a certain direction, through which light of certain visible wavelength bands passes, and by which light of the other visible wavelength bands is absorbed, and the solar panel 9 that is a cover target member which is provided under the semi-light-transmissive layer 14, and in which at least one second positioning mark section 15 where visible light passes through is provided at a portion to be covered by the first positioning mark section 13 in a planar view from above. As a result, the watch glass 8 and the solar panel 9 can be correctly positioned so that the internal structure becomes difficult to see.

More specifically, in the case of the glass structural body 6 of this wristwatch, when visible light is emitted from under the solar panel 9 toward the second positioning mark sections 15, part of the visible light which has passed through the second positioning mark sections 15 (through holes) passes through the cover sections 14a of the semi-light-transmissive layer 14, and is applied to the first positioning mark sections 13 and substantially completely absorbed at the first positioning mark sections 13. As a result, it is detected that the solar panel 9 has been correctly positioned under the watch glass 8.

In the case of the structure of the conventional wristwatch where the light-blocking sticker is directly attached to the upper surface of the timepiece movement on the inner circumference side of the solar panel so that the timepiece movement cannot be seen from the outside through the transparent dial plate, the positioning of the light-blocking sticker with respect to the timepiece movement is difficult. That is, with this structure, the internal structure can be obscured not to be easily seen, but the accurate positioning of component parts is difficult to perform. In contrast, in the case of the glass structural body 6 of this wristwatch, the positioning of component parts is accurately performed and the internal structure is prevented from being easily seen.

Also, in the case of the glass structural body 6 of this wristwatch, since the watch glass 8 includes the substantially annular light absorption layer 12 which is provided on the circumferential rim part of the watch glass 8 that can be visually recognized at least in a plane view from above, and absorbs visible light, external light passing through the watch glass 8 can be absorbed by the light absorption layer 12. As a result of this structure, external light is prevented from entering from the outer circumferential part of the watch glass 8, whereby the lower side of the circumferential rim part of the watch glass 8 becomes difficult to see.

Moreover, in the case of the glass structural body 6 of this wristwatch, the light absorption layer 12 is provided avoiding at least part of each first positioning mark section 13 in a planar view from above, and therefore does not come in contact or coincide with the first positioning mark sections 13. As a result of this structure, the light absorption layer 12 and the first positioning mark sections 13 can be favorably provided, whereby the space S1 can be formed between the light absorption layer 12 and each first positioning mark section 13. By this space S1, part of visible light can pass through.

In the case of the glass structural body 6 of this wristwatch in the present embodiment, the semicircular cutout sections 12a are formed to be open on the inner circumference side of the light absorption layer 12. In addition, on the portions of the undersurface of the watch glass 8 located in each cutout section 12a, the first positioning mark sections 13 which absorb visible light are provided with the spaces S1. As a result of this structure, part of visible light can pass through by each space S1 between the outer circumferential part of each first positioning mark section 13 and the inner circumferential part of the corresponding cutout section 12a of the light absorption layer 12.

That is, in the case of the glass structural body 6 of this wristwatch, the outer diameter of each first positioning mark section 13 is substantially equal to the radius of each cutout section 12a, and the center portion of each first positioning mark section 13 is arranged coinciding with the center portion of the corresponding cutout section 12a of the light absorption layer 12. As a result of this structure, the light absorption layer 12 and each first positioning mark section 13 do not come in contact or overlap with each other, and each space S1 can be unfailingly and favorably formed between the outer circumferential part of each first positioning mark section 13 and the inner circumferential part of the corresponding cutout section 12a of the light absorption layer 12.

Also, in the case of the glass structural body 6 of this wristwatch, each first positioning mark section 13 is formed at the inner circumference of the light absorption layer 12 in a planar view from above. As a result of this structure, the second positioning mark sections 15 can be easily provided under the first positioning mark sections 13, whereby the positioning of each second positioning mark section 15 with respect to the corresponding first positioning mark section 13 can be easily detected.

That is, in the case of the glass structural body 6 of this wristwatch, the first positioning mark sections 13 are provided on the inner circumference side of the light absorption layer 12, or in other words, at the inner circumference of the light absorption layer 12, and part of the outer circumferential rim of each first positioning mark section 13 is arranged to medially protrude further than the inner circumferential part of the light absorption layer 12 from the corresponding cutout section 12a of the light absorption layer 12, whereby the positioning of each second positioning mark section 15 with respect to the corresponding first positioning mark section 13 can be easily detected. Also, by being provided at the inner circumference of the light absorption layer 12 (provided coinciding with the inner circumference of the light absorption layer 12), the first positioning mark sections 13 appear to be substantially integrated with the light absorption layer 12, which prevents deterioration in appearance due to the first positioning mark sections 13 projecting inward.

Moreover, in the case of the glass structural body 6 of this wristwatch, the solar panel 9 has a substantially annular shape, and the inner diameter of the light absorption layer 12 is equal to or shorter than the outer diameter of the solar panel 9. Accordingly, the outer circumferential part of the solar panel 9 is unfailingly covered by the light absorption layer 12, whereby the internal structure is not easily seen. Also, since the inner diameter of the light absorption layer 12 is equal to or shorter than the outer diameter of the solar panel 9, the cutout sections 12a can be more inwardly formed, whereby the spaces S1 can be formed smaller. That is, the internal structure becomes difficult to see.

Furthermore, in the case of the glass structural body 6 of this wristwatch, the semi-light-transmissive layer 14 includes the cover sections 14a each of which is provided corresponding to the light absorption layer 12 and around each first positioning mark section 13 in a planar view from above. By these cover sections 14a, each space S1 between each first positioning mark section 13 and the light absorption layer 12 can be reliably covered, whereby the internal structure of the wristwatch case 1 such as the timepiece module (not shown in the drawings) is not easily seen through each space S1 between each first positioning mark section 13 and the light absorption layer 12.

That is, in the case of the glass structural body 6 of this wristwatch, each cover section 14a is provided projecting in a semicircular shape from an inner circumferential portion of the semi-light-transmissive layer 14 with a circumferential rim portion of each cover section 14a overlapping with a circumferential rim portion of the corresponding cutout section 12a of the light absorption layer 12. Accordingly, an area coinciding with each space S1 between the outer circumferential part of the corresponding first positioning mark section 13 and the inner circumferential part of the corresponding cutout section 12a and an area coinciding with and adjacent to an outer circumferential rim portion of the corresponding first positioning mark section 13 located at the inner circumference of the light absorption layer 12 can be reliably covered by the cover sections 14a, whereby only a certain amount of visible light passes through, and the internal structure of the wristwatch case 1 such as the timepiece module (not shown in the drawings) is not easily seen.

Also, in the case of the glass structural body 6 of this wristwatch, the light transmittance of each first positioning mark section 13 and that of the light absorption layer 12 are lower than the light transmittance of the semi-light-transmissive layer 14. Accordingly, even when part of visible light passes through the semi-light-transmissive layer 14 and the cover sections 14a, this light can be reliably absorbed by the first positioning mark sections 13 and the light absorption layer 12.

That is, in the case of the glass structural body 6 of this wristwatch, the light transmittance of the semi-light-transmissive layer 14 and those of the cover sections 14a are 5% to 15%, and should preferably be 10%. when the light transmittance of the semi-light-transmissive layer 14 and those of the cover sections 14a are about 10%, the light transmittance of the light absorption layer 12 and those of the first positioning mark section 13 are 0% to 5%, and should preferably be 0% (visible light does not pass therethrough at all).

As a result, in the case of the glass structural body 6 of this wristwatch, visible light which has passed through the semi-light-transmissive layer 14 and the cover sections 14a can be substantially fully absorbed by the first positioning mark sections 13 and the light absorption layer 12. In addition, in positioning detection, the positions of the second positioning mark sections 15 can be grasped especially through the cover sections 14a. That is, by the semi-light-transmissive layer 14 and the cover sections 14a being provided, positioning detection can be performed, and the internal structure of the wristwatch case 1 such as the timepiece module (not shown in the drawings) is not easily seen through the spaces S1 when the wristwatch with this glass structural body 6 is being used.

Also, in the case of the glass structural body 6 of this wristwatch, the second positioning mark sections 15 are through holes and their outer diameters are shorter than those of the first positioning mark sections 13. Accordingly, the second positioning mark sections 15 can be unfailingly covered by the first positioning mark sections 13. As a result of this structure, when visible light which has been emitted to and has passed through the second positioning mark sections 15 is applied to the first positioning mark sections 13, this applied visible light can be unfailingly absorbed, whereby the solar panel 9 can be correctly positioned with respect to the watch glass 8.

That is, in the case of the glass structural body 6 of this wristwatch, when visible light is emitted from under the solar panel 9 toward the second positioning mark sections 15, part of this visible light which has passed through the through holes of the second positioning mark sections 15 passes through the cover sections 14a of the semi-light-transmissive layer 14, and is substantially completely absorbed at the first positioning mark sections 13, whereby it is detected that the solar panel 9 has been correctly positioned under the watch glass 8.

Moreover, in the case of the glass structural body 6 of this wristwatch, when part of visible light emitted from under the solar panel 9 toward the second positioning mark sections 15 is not fully absorbed at the first positioning mark sections 13, leaks above the first positioning mark sections 13, and is seen from above the watch glass 8 as shown in FIG. 9A and FIG. 9B, it is detected that the second positioning mark sections 15 have been slightly mispositioned with respect to the first positioning mark sections 13.

Accordingly, it is only required that at least the light transmittance of the light absorption layer 12 and those of the first positioning mark sections 13 and the light transmittance of the semi-light-transmissive layer 14 and those of the cover sections 14a have a relation by which a state where the second positioning mark sections 15 have been slightly mispositioned with respect to the first positioning mark sections 13 and part of visible light has leaked above the first positioning mark sections 13 can be detected from above the watch glass 8 by eye or an optical sensor.

Also, in the case of the glass structural body 6 of this wristwatch, the situation where the second positioning mark sections 15 of the glass structural body 6 have been mispositioned with respect to the first positioning mark sections 13 and located at positions shifted therefrom as shown in FIG. 9A and FIG. 9B is not acceptable. Here, in the glass structural body 6 of this wristwatch, areas required to be tinted (obscured) are areas which can be seen through the spaces S1, that is, areas between the light absorption layer 12 and the solar panel 9 (or each first positioning mark section 13). By being tinted by the cover sections 14a of the semi-light-transmissive layer 14, these areas are obscured not to be easily seen.

Also, the manufacturing method for manufacturing the glass structural body 6 of this wristwatch includes the first step of providing, on the watch glass 8 which is a cover member where at least visible light passes through, at least one first positioning mark section 13 which absorbs visible light, and the semi-light-transmissive layer 14 which extends around the first positioning mark section 13 in a planar view from above, through which light of certain visible wavelength bands passes, and by which light of the other visible wavelength bands is absorbed, a second step of providing at least one second positioning mark section 15 where visible light passes through in a portion of the solar panel 9 serving as a cover target member which is covered by the first positioning mark section 13 in a planar view from above, and a third step of emitting visible light toward the watch glass 8 from the solar panel 9 side and detecting the positioning of the second positioning mark section 15 of the solar panel 9 and the first positioning mark section 13 of the watch glass 8. As a result, the watch glass 8 and the solar panel 9 can be correctly positioned so that the internal structure becomes difficult to see.

That is, in the manufacturing method for the glass structural body 6 of this wristwatch, when the solar panel 9 is to be positioned with respect to the watch glass 8 at the third step, visible light is emitted from under the solar panel 9 toward the second positioning mark section 15, and part of the visible light which has passed the through hole of the second positioning mark section 15 passes through the corresponding cover section 14a of the semi-light-transmissive layer 14, and is applied to the first positioning mark section 13 and substantially completely absorbed at the first positioning mark section 13, whereby it is detected that the solar panel 9 has been correctly positioned under the watch glass 8.

Also, in the manufacturing method for the glass structural body 6 of this wristwatch, when part of the visible light emitted from under the solar panel 9 toward the second positioning mark section 15 passes through the corresponding cover section 14a of the semi-light-transmissive layer 14, and this part of the visible light is not fully absorbed at the first positioning mark section 13, leaks above the first positioning mark section 13, and is seen from above the watch glass 8 as shown in FIG. 9A and FIG. 9B, it is detected that the second positioning mark section 15 has been slightly mispositioned with respect to the first positioning mark section 13.

In the manufacturing method for the glass structural body 6 of this wristwatch, the situation where the second positioning mark section 15 of the solar panel 9 has been slightly mispositioned with respect to the first positioning mark section 13 and located at a position shifted therefrom at the third step is not acceptable. Here, in the glass structural body 6, an area required to be tinted (obscured) is an area that can be seen through the corresponding space S1, that is, an area between the light absorption layer 12 and the solar panel 9 (or the first positioning mark section 13). By being translucent, that is, by being tinted by the cover section 14a of the semi-light-transmissive layer 14, this area is obscured not to be easily seen.

In the above-described embodiment, the shape of each first positioning mark section 13 and that of each second positioning mark section 15 are circular. However, the present disclosure is not limited thereto. For example, a structure may be adopted in which the shape of each first positioning mark section 13 and that of each second positioning mark section 15 are quadrangular.

Also, in the above-described embodiment and the modification example, the circular first positioning mark sections 13 and the circular second positioning mark sections 15 are provided on the three o'clock side and the nine o'clock side. However, the present disclosure is not limited thereto, and the first positioning mark sections 13 and the second positioning mark sections 15 in the above-described embodiments are not necessarily required to be provided on the three o'clock side and the nine o'clock side. For example, a structure may be adopted in which a first positioning mark section in a quadrilateral or similar shape and a second positioning mark section in a quadrilateral or similar shape are provided on one of the three and nine o'clock sides, and one of the first positioning mark sections 13 and one of the second positioning mark sections 15 in the above-described embodiment are provided on the other side.

Moreover, in the above-described embodiment and the modification example, although the first positioning mark sections 13 and the second positioning mark sections 15 are provided on the three o'clock side and the nine o'clock side, the present disclosure is not limited thereto, and they may be provided at any points as long as they are at the same circumference. In addition, they are not necessarily required to be provided at two points, and may be provided at one point or three or more points.

Furthermore, in the above-described embodiment and the modification example, the first positioning mark sections 13 and the second positioning mark sections 15 are formed in a circular shape or a quadrangular shape. However, the present disclosure is not limited thereto. For example, they may have a polygonal shape such as a pentagonal shape and a hexagonal shape, or an oval shape

Still further, in the above-described embodiment, the solar panel 9 is formed in a substantially annular shape. However, the present disclosure is not limited thereto, and the solar panel 9 may be formed in a circular shape.

Still further, in the above-described embodiment, the present disclosure has been applied in a wristwatch. However, the present disclosure is not necessarily required to be applied in a wristwatch. For example, the present disclosure is applicable to various types of timepieces such as a travel watch, an alarm clock, a table clock, and a wall clock. In addition, the present disclosure is not necessarily required to be applied in timepieces, and can be applied in electronic devices such as meter gauges.

While the present disclosure has been described with reference to the preferred embodiment, it is intended that the present disclosure be not limited by any of the details of the description therein but includes all the embodiments which fall within the scope of the appended claims.

What is claimed is:

1. A cover structural body comprising:
a cover member through which at least visible light passes and which is provided with at least one first positioning mark portion that absorbs visible light;
a semi-light-transmissive layer which is provided at same height as or below the first positioning mark portion while extending around the first positioning mark portion in a planar view from a certain direction, through which light of certain visible wavelength bands passes, and by which light of other visible wavelength bands is absorbed; and
a cover target member which is provided under the semi-light-transmissive layer, and in which at least one second positioning mark portion where visible light passes through is provided at a portion to be covered by the first positioning mark portion in the planar view from the certain direction.

2. The cover structural body according to claim 1, wherein the cover member has an annular light absorption layer which is provided on a circumferential rim part that is visually recognizable at least in the plane view from the certain direction, and absorbs visible light.

3. The cover structural body according to claim 2, wherein the light absorption layer is provided avoiding at least part of the first positioning mark portion in the planar view from the certain direction.

4. The cover structural body according to claim 3, wherein the first positioning mark portion is provided at an inner circumference of the light absorption layer in the planar view from the certain direction.

5. The cover structural body according to claim 4, wherein the cover target member has a circular or annular shape, and an inner diameter of the light absorption layer is equal to or shorter than an outer diameter of the cover target member.

6. The cover structural body according to claim 5, wherein the semi-light-transmissive layer includes an overlapping portion which is provided corresponding to the light absorption layer and around the first positioning mark portion in the planar view from the certain direction.

7. The cover structural body according to claim 2, wherein light transmittance of the first positioning mark portion and light transmittance of the light absorption layer are lower than light transmittance of the semi-light-transmissive layer.

8. The cover structural body according to claim 1, wherein the second positioning mark portion is a through hole whose outer diameter is shorter than an outer diameter of the first positioning mark portion.

9. A timepiece comprising the cover structural body according to claim 1.

10. A manufacturing method for manufacturing a cover structural body, comprising:
a first step of providing, on a cover member where at least visible light passes through, at least one first positioning mark portion which absorbs visible light, and a semi-light-transmissive layer which extends around the first positioning mark portion in a planar view from a certain direction, through which light of certain visible wavelength bands passes, and by which light of other visible wavelength bands is absorbed;
a second step of providing at least one second positioning mark portion where visible light passes through in a portion of a cover target member to be covered by the first positioning mark portion in the planar view from the certain direction; and
a third step of emitting visible light toward the cover member from the cover target member side, and detecting positioning of the second positioning mark portion of the cover target member and the first positioning mark portion of the cover member.
